(19) United States
(12) Patent Application Publication
(10) Pub. No.: US 2023/0194080 A1
(43) Pub. Date: Jun. 22, 2023

(54) METHOD AND APPARATUS FOR REMOVING POLLUTANTS FROM ORGANIC SOLID WASTE BY PYROLYSIS COUPLED WITH CHEMICAL LOOPING COMBUSTION

(71) Applicant: GUANGZHOU INSTITUTE OF ENERGY CONVERSION, CHINESE ACADEMY OF SCIENCES, Guangzhou (CN)

(72) Inventors: Zhen HUANG, Guangzhou (CN); Yan LIN, Guangzhou (CN); Haoran YUAN, Guangzhou (CN); Guoqiang WEI, Guangzhou (CN); Anqing ZHENG, Guangzhou (CN); Kun ZHAO, Guangzhou (CN); Zengli ZHAO, Guangzhou (CN); Haibin LI, Guangzhou (CN)

(73) Assignee: GUANGZHOU INSTITUTE OF ENERGY CONVERSION, CHINESE ACADEMY OF SCIENCES, Guangzhou (CN)

(21) Appl. No.: 17/926,148

(22) PCT Filed: Jan. 29, 2022
(86) PCT No.: PCT/CN2022/074859

§ 371 Date: Nov. 18, 2022

(30) Foreign Application Priority Data
Dec. 25, 2020 (CN) 202011560972.8
Jun. 11, 2021 (CN) 202110654553.9

(51) Int. Cl. F23G 5/027; F23C 99/00; F23G 5/16

(52) U.S. Cl. CPC F23G 5/0273; F23C 99/00; F23G 5/16; F23C 2900/99008; F23G 2201/303; F23G 2202/103; F23G 2204/103; F23G 5/46

(57) ABSTRACT

A method and apparatus for removing pollutants from organic solid waste by pyrolysis coupled with chemical looping combustion are provided. The apparatus includes: an air reactor, a fuel reactor, and a pyrolysis gasifier. The pyrolysis gasifier is sleeved outside the fuel reactor, and the air reactor is connected with the fuel reactor. A top end of the air reactor is connected with a top delivery pipe; the top delivery pipe is connected with a first cyclone separator; and the first cyclone separator is connected with an oxygen carrier refeeder provided at a top end of the fuel reactor. The apparatus forms a two-stage reaction unit of pyrolysis and chemical looping combustion by decoupling the pyrolysis process from the chemical looping combustion, which avoids the contact between the complex ash of organic solid waste and the oxygen carrier, thereby improving the service life of the oxygen carrier.

### CROSS REFERENCE TO THE RELATED APPLICATIONS

This application is the national phase entry of International Application No. PCT/CN2022/074859, filed on Jan. 29, 2022, which is based upon and claims priority to Chinese Patent Applications No. 202011560972.8 filed on Dec. 25, 2020 and No. 202110654553.9 filed on Jun. 11, 2021, the entire contents of which are incorporated herein by reference.

### TECHNICAL FIELD

The present invention relates to the field of environmental protection and energy utilization technologies, in particular to a method and apparatus for removing pollutants from organic solid waste by pyrolysis coupled with chemical looping combustion.

### BACKGROUND

Organic solid waste refers to solid and semi-solid organic waste substances generated by human in production, consumption, life and other activities. With the development of economy and the improvement of people's living standard, the production of organic solid waste substances (hereinafter referred to as “organic solid waste”) are increasing, which may seriously endanger the ecological environment and human health if the waste is not properly treated.

At present, the manner for treating and disposing the organic solid waste mainly includes landfill, composting and incineration. As shown by numerous studies, both the sanitary landfill and composting may not only take up a lot of land and cost a rather long time, but also cause serious damages to the nearby ecological environment due to the permeation of waste. For the incineration which is the most widely used means at present for disposing the organic solid waste, it may make the toxic organic substances and pathogenic microorganisms in the waste lose their toxicity by decomposition at high temperatures. Thus, the incineration has advantages of a high volume and weight reduction rate and a fast treatment speed, and may further realize the energy utilization of waste by recovering the heat generated during the incineration process. In general, the incineration is the most suitable mode for disposing the organic solid waste since it can achieve not only the energy recovery but also a complete non-pollution and reduction. However, flue gas generated by incineration of the organic solid waste contains a great amount of SOₓ, NOₓ and harmful substances such as dioxins and heavy metal particles, which may easily cause pollution to the environment. In addition, the initial investment in sludge incineration equipment is rather great, and the incineration of the flue gas is expensive and difficult.

Pyrolysis gasification technology is an emerging organic solid waste disposing technology, and refers to a process in which organic substances in the solid waste are converted into combustible gases containing H₂, CH₄, CO, CₙHₘ, tar and ash via a series of thermochemical reactions under certain temperature and pressure conditions and in the absence of oxygen or oxygen-deficient environment. Compared with the incineration, the pyrolysis gasification produces less harmful gas emissions such as SO₂ and NOₓ. In addition, most of the heavy metals are solidified in the ash, and thereby has a low leaching toxicity, and a relatively low treatment cost. However, due to the high volatile content of organic solid waste, a certain amount of tar and pollutants such as N/S/Cl may be generated during the pyrolysis gasification process, thereby causes certain environmental risks.

Chemical looping combustion (CLC), which is a novel combustion technology (shown in FIG. 1), refers to a process in which the lattice oxygen in the oxygen carrier of metal oxide (MeO) is used in a looping reaction to completely oxidize the fuel to CO₂ and H₂O in a fuel reactor, and the reduced oxygen carrier (Me) after the reaction is re-oxidized by air in an air reactor to restore the lattice oxygen for recycling. In an inert atmosphere of the fuel reactor, the fuel may first undergo pyrolysis to release reduced N/S/Cl pollutants and tar (which is somewhat reductive). The removal of reduced pollutants is easier to achieve than the removal of oxidized pollutants. For example, HCN and NH₃ may be oxidized to harmless N₂ by an oxygen carrier during the chemical looping combustion, whereas NOₓ can only be effectively removed by a more complex SNCR/SCR system. In addition, by loading exogenous metal ions onto the oxygen carrier and regulating types and loading of the metal ions, the tar and the N/S/Cl pollutants can be removed together in the fuel reactor. Compared with the conventional incineration, the chemical looping combustion can greatly reduce the difficulty in removing the pollutants. However, the organic solid waste generally contains complex ash, which may easily cause sintering and corrosion to the oxygen carrier and reduce the cycle reactivity and lifetime of the oxygen carrier. Therefore, exploring and developing an organic solid waste disposing technology with low initial investment, low operating cost and low pollutant emission is an important step to alleviate the increasingly serious solid waste disposing situation in China.

### SUMMARY

The present invention provides a method and apparatus for removing pollutants from organic solid waste by pyrolysis coupled with chemical looping combustion. Compared with the traditional incineration technology, the method and apparatus according to the present invention have a rather smaller initial investment and a lower cost and difficulty in treating the incineration flue gas; and compared with pyrolysis gasification technology, the tar and N/S/Cl pollutants can be removed together, which has a simple treatment process and low cost.

An object of the present invention is to provide an apparatus for removing pollutants from organic solid waste by pyrolysis coupled with chemical looping combustion. The apparatus comprises: an air reactor, a fuel reactor and a pyrolysis gasifier, wherein the pyrolysis gasifier is sleeved outside the fuel reactor; the air reactor is connected with the fuel reactor by a U-type refeeder; a top end of the air reactor is connected with an end of a top delivery pipe, another end of the top delivery pipe is connected with a top end of a first cyclone separator, and a bottom end of the first cyclone separator is connected with an oxygen carrier refeeder provided at a top end of the fuel reactor; an air inlet is provided at a bottom of the air reactor; a fluidized gas nozzle and several jet devices is provided at a lower part of the fuel reactor is provided, and a feeder is provided on one side of the pyrolysis gasifie. A system for utilizing and purifying waste heat of flue gas is provided on the top of the first cyclone separator, and the system includes a waste heat utilization boiler, a small lime slurry absorption tower, or a flue gas purification system of a thermal power plant.

Preferably, the lower part of the fuel reactor is equipped with a fluidized gas nozzle and a first jet device and a second jet device disposed on two sides of the fluidized gas nozzle; the first jet device consists of a first jet nozzle and a first L-shaped jet chamber, the second jet device consists of a second jet nozzle and a second L-shaped jet chamber; and a first jet gas nozzle and a second jet gas nozzle are provided on both sides of a bottom part of the pyrolysis gasifier; jet gas in first jet gas pipeline is ejected by the first jet nozzle at an inlet of the first L-shaped jet chamber, such that high-speed jet gas generates a local negative pressure and thereby draws pyrolysis gas of solid waste within the pyrolysis gasifier into the first L-shaped jet chamber; jet gas in second jet gas pipeline is ejected by the second jet nozzle at an inlet of the second L-shaped jet chamber, such that high-speed jet gas generates a local negative pressure and thereby draws pyrolysis gas of solid waste within the pyrolysis gasifier into the second L-shaped jet chamber.

Further preferably, the top end of the fuel reactor is connected with the second cyclone separator, such that flue gas in the fuel reactor is separated from solids by the second cyclone separator, then, the flue gas from gas-solid separation passes through an outlet pipe of the second cyclone separator and serves as jet gas in first jet gas pipeline at the bottom of the fuel reactor, fluidized gas entering the fluidized gas nozzle via a fluidized gas pipeline, and refeeder gas in a refeeder gas pipeline, respectively.

Further preferably, the refeeder gas pipeline is provided at the bottom of the U-type refeeder for circulating the refeeder gas.

Further preferably, a first natural gas inlet is provided at bottom of the air reactor, the jet gas pipeline comprises a first jet gas pipeline and a second jet gas pipeline; the first jet gas pipeline is provided with a second natural gas inlet, and the second jet gas pipeline is provided with a third natural gas inlet.

Further preferably, the air inlet is provided with an air control valve; the refeeder gas pipeline is provided with a refeeder gas control valve; the first natural gas inlet is provided with a first natural gas control valve, the second natural gas inlet is provided with a second natural gas control valve, the third natural gas inlet is provided with a third natural gas control valve; the fluidized gas tube is provided with a fluidized gas control valve, the first jet gas pipeline is provided with a first jet gas control valve, and the second jet gas pipeline is provided with a second jet gas control valve.

Further preferably, outlet pipeline of the second cyclone separator is provided with a carbon dioxide capturing device.

Preferably, a slag discharge device is provided on a lower part of the pyrolysis gasifier.

The present invention further seeks to protect a method for removing pollutants from organic solid waste by pyrolysis coupled with chemical looping combustion. The method is implemented by the apparatus for removing pollutants from organic solid waste by pyrolysis coupled with chemical looping combustion, and comprises steps of:

S1: placing the oxygen carrier respectively in the air reactor, U-type refeeder, oxygen carrier refeeder, and fuel reactor; starting an air booster fan that provides air, and taking the air as fluidized gas; turning on an air switching valve, and controlling a gas flow rate of the air reactor, fuel reactor, U-type refeeder and oxygen carrier refeeder by controlling the air control valve, refeeder gas control valve, first jet gas control valve, fluidized gas control valve and second jet gas control valve to realize cyclic fluidization of the oxygen carrier;

S2: turning on the second natural gas control valve and the third natural gas control valve to increase input of natural gas, igniting the natural gas by an electric spark igniter in the fuel reactor, and transporting flue gas and the oxygen carrier to the air reactor via the U-type refeeder; turning on the first natural gas control valve to burn the natural gas in the air reactor, and sequentially turning off the first natural gas control valve, the second natural gas control valve, and the third natural gas control valve after both the air reactor and the fuel reactor are raised to 800° C.-1000° C.; and meanwhile turning off the air switching valve, turning on the flue gas booster fan on a flue gas pipeline, and turning on a flue gas bypass control valve on the flue gas pipeline to convert the fluidized gas and jet gas of the fuel reactor to recirculate flue gas in the flue gas pipeline of the fuel reactor;

S3: continuously feeding organic solid waste of a storage bin into the pyrolysis gasifier via a feeder, and meanwhile turning on the first jet gas control valve and the second jet gas control valve, such that pyrolysis gas in the pyrolysis gasifier is sucked into the fuel reactor by negative pressures generated in the first L-shaped jet chamber and second L-shaped jet chamber and further undergoes chemical looping combustion under the oxygen carrier; then, acquiring reduced oxygen carrier after reaction of oxidized oxygen carrier, and discharging residual solids as remained after reaction of the organic solid waste from a lower part of the pyrolysis gasifier via a slag discharge device; and

S4: making the reduced oxygen carrier after reaction enter the U-type refeeder and then enter the air reactor under the refeeder gas; fully oxidizing the reduced oxygen carrier in an air atmosphere to acquire the oxidized oxygen carrier, and releasing heat which is absorbed by the oxidized oxygen carrier and oxygen-poor air after reaction; then, transporting the oxidized oxygen carrier and the oxygen-poor air to the first cyclone separator via a top delivery pipe after they enter a fast bed in the upper part of the air reactor, and separating the oxygen-poor air from the oxidized oxygen carrier, such that the oxidized oxygen carrier finally fall into the fuel reactor via the oxygen carrier refeeder; and the oxidized oxygen carrier provide oxygen source for combustion of the pyrolysis gas and provide heat to maintain reaction of the chemical looping combustion.

In the present invention, the pyrolysis gasification served as the pre-treatment of organic solid waste, and the pyrolysis gas as generated then enters into a chemical looping combustion apparatus, which not only realizes the efficient and harmless disposal of organic solid waste, but also avoids the negative effect of ash on the oxygen carrier. Thus, it is a very innovative idea for disposing the organic solid waste. In the present invention, the organic solid waste is treated by pyrolysis gasification coupled with chemical looping combustion, which can not only achieve efficient reduction, harmlessness and resource utilization of organic solid waste, but also greatly reduces the difficulty in removing the pollutants during the disposal process, thereby providing a new way for effectively and cleanly disposing the organic solid waste and resource utilization of organic solid waste.

The method for removing pollutants from organic solid waste by pyrolysis coupled with chemical looping combustion in the present invention includes two processes, i.e., the pyrolysis gasification of organic solid waste and the chemical looping combustion of gas products. The schematic diagram is shown in FIG. 2. The process for the pyrolysis gasification of organic solid waste includes converting the organic solid waste feedstock into pyrolysis gas via the pyrolysis gasifier. The process for the chemical looping combustion of gas products includes converting the pyrolysis gas of organic solid waste containing great amounts of tar and N/S/Cl pollutants into clean exhaust gas (CO₂/H₂O/N₂) by a chemical looping combustion apparatus, and solidifying element S/Cl on the oxygen carrier.

The chemical looping combustion apparatus includes a fuel reactor and an air reactor. In the fuel reactor, the pyrolysis gas reacts with the metal oxide oxygen carrier, the tar and combustible gases (H₂/CO/CH₄, etc.) are converted to CO₂ and H₂O, the pollutant N is converted to N₂, and the pollutant S/CI is solidified on the oxygen carrier. In the air reactor, the reduced oxygen carrier is fully calcined in air to be re-oxidized, and this process may release a great amount of heat and can meet the heat demand of the fuel reactor and pyrolysis gasification reactor, which realize the self-heating operation of the whole system of pyrolysis coupled with chemical looping combustion. As to a small amount of pollutant gas S/Cl as possibly produced by the air reactor, it may be removed by equipping with a small lime slurry absorption tower or by utilizing an existing flue gas purification system of the thermal power plant.

Preferably, the oxygen carrier is a natural metallic ore, the natural metallic ore is selected from more than one of iron ore, copper ore, manganese ore and nickel ore.

The beneficial effect of the present invention compared with the prior art lies in following aspects.

1. Compared with the chemical looping combustion apparatus, the apparatus of the present invention forms a two-stage reaction unit of pyrolysis and chemical looping combustion by decoupling the pyrolysis process from the chemical looping combustion, which avoids the contact between the complex ash of organic solid waste and the oxygen carrier, and thereby improves the service life of the oxygen carrier.

2. Compared with the air incineration apparatus, the apparatus of the present invention treats the pyrolysis gas of the solid waste by the chemical looping combustion featured in low pollutant emission, which can remove the tar and the N/S/Cl pollutants together.

3. The apparatus of the present invention has a small initial investment and low operating cost, and is suitable for application in small treatment capacity scenarios. Furthermore, the apparatus can remove the small amount of pollutant gas S/Cl as produced by the air reactor by equipping with a small flue gas purification system or utilizing an existing flue gas purification system of the thermal power plant.

4. Natural metal ores are selected as the oxygen carrier (iron ore/copper ore/manganese ore/nickel ore, etc.), and the performance of the oxygen carrier for removing the tar and the N/S/Cl pollutants is enhanced by loading/doping with exogenous ions such as K/Ca/Na/Ni/Mn/Cu.

5. Compared with the pyrolysis gasification apparatus, the system of pyrolysis gasification coupled with chemical looping combustion can realize the self-heating operation in an almost oxygen-free atmosphere, and the reduced oxygen carrier as calcined in the air reactor may release a great amount of heat which is enough to meet the reaction needs of the pyrolysis gasification reactor and the fuel reactor.

### BRIEF DESCRIPTION OF THE DRAWINGS

FIG. 1 is a principle schematic diagram of a chemical looping combustion technology;

FIG. 2 is a principle schematic diagram for removing pollutants from organic solid waste by pyrolysis coupled with chemical looping combustion of the present invention;

FIG. 3 is a schematic structural diagram of an apparatus for removing pollutants from organic solid waste by pyrolysis coupled with chemical looping combustion of the present invention, wherein the arrow at the top delivery pipe shows a flow direction of the oxygen carrier and flue gas, the arrow at the top of the fuel reactor shows a flow direction of flue gas, and the arrow at the bottom of the fuel reactor shows a flow direction of fluidized gas; and

FIG. 4 is a comparison diagram for morphological distribution of element N between the pyrolysis process and the chemical looping conversion process of the present invention.

Description of the reference signs: 1, Air reactor; 1-1, Air booster fan; 1-2, Air control valve; 1-3, Inverted cone-shaped nozzle; 1-4, Porous air distribution plate; 1-5, First natural gas control valve; 1-6, Top delivery pipe; 1-7, First cyclone separator; 1-8, Oxygen carrier refeeder; 2, U-type refeeder; 2-1, Refeeder gas control valve; 3, Fuel reactor; 3-1, Flue gas bypass control valve; 3-2, Flue gas booster fan; 3-3, Second cyclone separator; 3-4, First electric spark igniter; 3-5, Porous air distribution plate; 3-6, First L-shaped jet chamber; 3-7, Inverted cone-shaped fluidized gas nozzle; 3-8, Fluidized gas control valve; 3-9, First jet nozzle, 3-10, Second natural gas control valve; 3-11, First jet gas control valve; 3-12, Second jet gas control valve; 3-13, Third natural gas control valve; 3-14, Second jet nozzle; 3-15, Second L-shaped jet chamber; 3-16, Second electric spark igniter; 4, Pyrolysis gasifier; 4-1, Storage bin; 4-2, Spiral feeder; 4-3, First jet gas nozzle; 4-4, First jet gas control valve; 4-5, First spiral slag discharge device; 4-6, Second spiral slag discharge device; 4-7, Second jet gas control valve; 4-8, Second jet air nozzle; 5, Air switching valve.

### DETAILED DESCRIPTION OF THE EMBODIMENTS

The following embodiments are intended to further illustrate the present invention rather than limit the present invention. Unless otherwise specified, the equipment and reagents applied in the present invention are conventional commercially available products in the prior art.

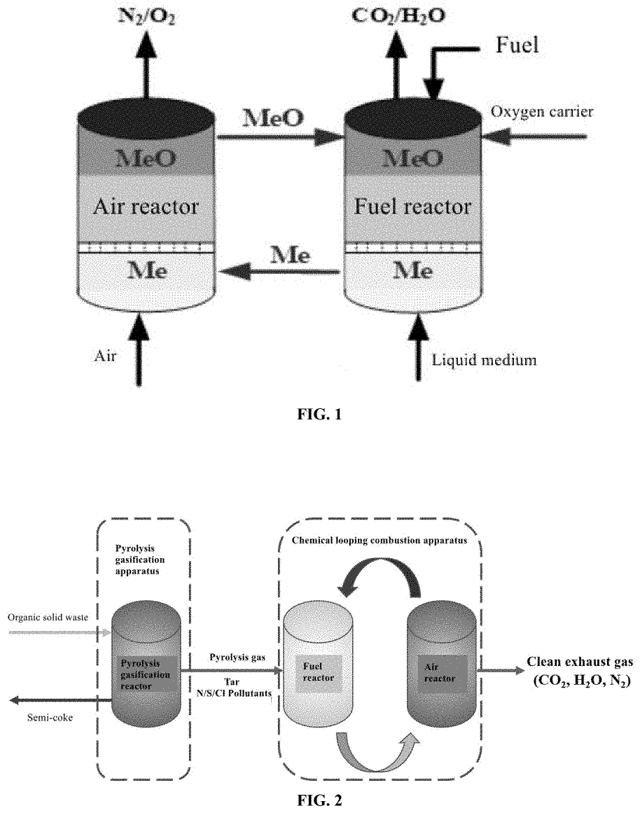

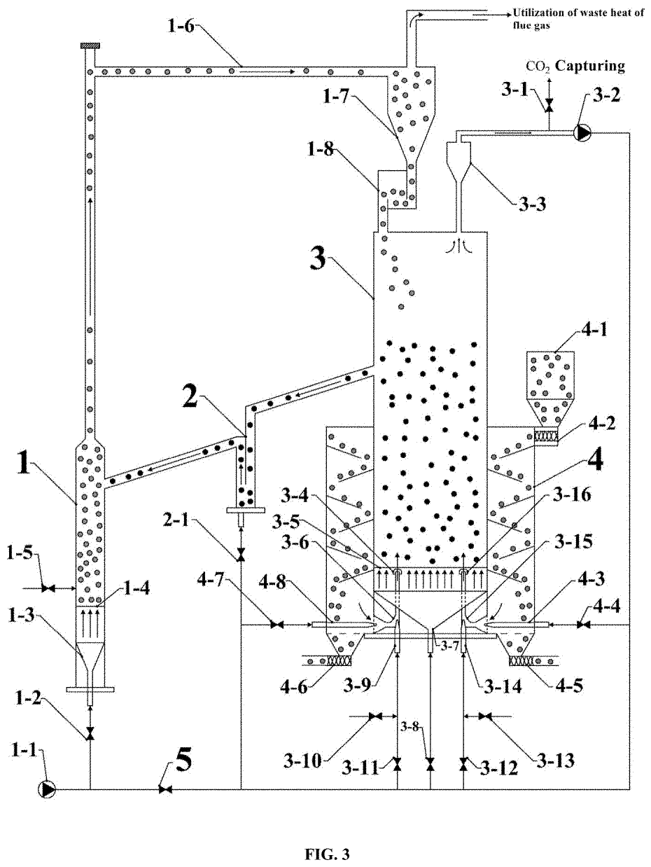

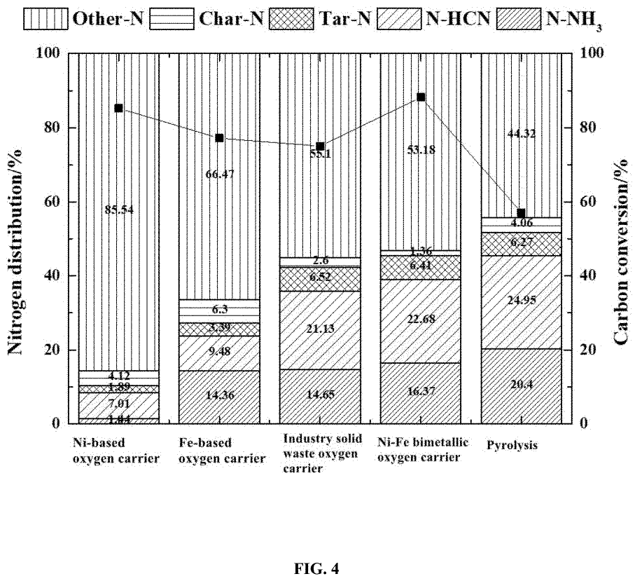

FIG. 1 shows an apparatus for removing pollutants from organic solid waste by pyrolysis coupled with chemical looping combustion, which comprises an air reactor 1, a fuel reactor 3 and a pyrolysis gasifier 4. The pyrolysis gasifier 4 is sleeved outside the fuel reactor 3, and the air reactor 1 is connected with the fuel reactor 3 by a U-type refeeder 2. The top end of the air reactor 1 is connected with an end of a top delivery pipe 1-6, another end of the top delivery pipe 6 is connected with the top end of a first cyclone separator 1-7, and the bottom end of the first cyclone separator 1-7 is connected with an oxygen carrier refeeder 1-8 provided at the top end of the fuel reactor 3. An air inlet is provided at the bottom of the air reactor 1, and a fluidized gas nozzle and several jet devices are provided at the lower part of the fuel reactor 3. The fluidized gas nozzle in the following embodiments is preferably an inverted cone-shaped fluidized gas nozzle 3-7. A feeder is provided on one side of the pyrolysis gasifier 4. The feeder in the following embodiments is preferably a spiral feeder 4-2, and the spiral feeder 4-2 is provided with a storage bin 4-1 to facilitate the feeding. A system for utilizing and purifying waste heat of flue gas is provided at the top of the first cyclone separator 1-7, and the system includes a waste heat utilization boiler, a small lime slurry absorption tower, or a flue gas purification system of a thermal power plant.

The lower part of the fuel reactor 3 is equipped with the inverted cone-shaped fluidized gas nozzle 3-7 and a first jet device and a second jet device disposed on two sides of the fluidized gas nozzle. The first jet device consists of a first jet nozzle 3-9 and a first L-shaped jet chamber 3-6, and the second jet device consists of a second jet nozzle 3-14 and a second L-shaped jet chamber 3-15. A first jet gas nozzle 4-3 and a second jet gas nozzle 4-8 are provided on two sides of the bottom of the pyrolysis gasifier 4. The jet gas in the first jet gas pipeline may generate a local negative pressure at the inlet of the first L-shaped jet chamber 3-6 via the first jet nozzle 3-9, which draws the pyrolysis gas of solid waste from the pyrolysis gasifier into the first L-shaped jet chamber 3-6. The jet gas in the second jet gas pipeline may pass through the second jet nozzle 3-14 and generate a local negative pressure at the inlet of the second L-shaped jet chamber 3-15, which draws the pyrolysis gas of solid waste from the pyrolysis gasifier into the second L-shaped jet chamber 3-15.

The top end of the fuel reactor 3 is connected with the second cyclone separator 3-3, such that flue gas in the fuel reactor 3 is separated from solids by the second cyclone separator 3-3. Then, the flue gas from gas-solid separation passes through an outlet pipe of the second cyclone separator and serves as jet gas in the jet gas pipeline at the bottom of the fuel reactor, fluidized gas entering the fluidized gas nozzle via a fluidized gas pipeline, and refeeder gas in the refeed gas pipeline.

A refeeder gas pipeline is provided at the bottom of the U-type refeeder 2 for circulating the refeeder gas. A first natural gas inlet is provided at the bottom of the air reactor, The jet gas pipeline comprises a first jet gas pipeline and a second jet gas pipeline. The first jet gas pipeline is provided with a second natural gas inlet, and the second jet gas tube is provided with a third natural gas inlet.

An air control valve 1-2 is provided at the air inlet; a refeeder gas control valve 2-1 is provided on the refeeder gas pipeline; a first natural gas control valve 1-5 is provided at the first natural gas inlet, a second natural gas control valve 3-10 is provided at the second natural gas inlet, and a third natural gas control valve 3-13 is provided at the third natural gas inlet; and a fluidized gas control valve 3-8 is provided on the fluidized gas pipeline a first jet gas control valve 3-11 is provided on the first jet gas pipeline, and a second jet gas control valve 3-12 is provided on the second jet gas pipeline. A carbon dioxide capturing device is provided on the outlet pipe of the second cyclone separator.

The working process of each reactor of the apparatus is as follows.

For the air reactor 1, its upper part is a fast bed, and its lower part is a bubbling bed; the air is used as the fluidized gas (the flow rate is controlled by the air control valve 1-2 and the air booster fan 1-1). The function of the porous air distribution plate 1-4 as provided in the lower part of the air reactor is to limit the lower boundary of the fluidized oxygen carrier, and the air may enter the air reactor via the inverted cone-shaped nozzle 1-3 and the porous air distribution plate 1-4 at the bottom. The reduced oxygen carrier from the fuel reactor enters the U-type refeeder 2 (the lower part of the U-type rebate 2 is fed with refeeder gas and controlled by the refeeder gas control valve 2-1), and the reduced oxygen carrier enters the air reactor 1 under the action of the refeeder gas. The reduced oxygen carrier is fully oxidized in the air atmosphere and releases a large amount of heat, which is absorbed by the oxidized oxygen carrier and oxygen-poor air after reaction. The oxidized oxygen carrier and oxygen-poor air may enter the fast bed in the upper part of the air reactor 1, and are transported to the first cyclone separator 1-7 via the top delivery pipe 1-6. Then, the oxygen-poor air is separated from the oxygen carrier, and the oxygen carrier pass through the oxygen carrier refeeder 1-8 and finally falls into the fuel reactor 3. Afterwards, the reduced oxygen carrier is fully oxidized in the air reactor 1 and acts as a heat carrier to absorb the oxidation reaction heat, and then is finally delivered to the fuel reactor 3 to provide an oxygen source for pyrolysis gas combustion and heat to maintain the reaction temperature.

For the fuel reactor 3, it is a bubbling fluidized bed, and its upper part is connected to an oxygen carrier refeeder 1-8 and a second cyclone separator 3-3, respectively. The oxygen carrier refeeder 1-8 herein serves to receive the oxidized oxygen carrier from the air reactor 1, and the second cyclone separator 3-3 serves to prevent the outlet flue gas from carrying the oxygen carrier particles. The lower part of the fuel reactor 3 is equipped with an inverted cone-shaped fluidized gas nozzle 3-7 and a jet device consisting of a first jet nozzle 3-9, a second jet nozzle 3-14, a first L-shaped jet chamber 3-6 and a second L-shaped jet chamber 3-15. The outlet flue gas of the fuel reactor 3 is discharged via the outlet pipe of the second separator. A part of the outlet flue gas is discharged into a CO₂ capturing device via a bypass of the outlet pipe of the second separator (the flow rate as discharged is controlled by the flue gas bypass control valve 3-1), and the other part enters the flue gas booster fan 3-2, and is pressurized for supplying the fluidized gas and jet gas. The role of the fluidized gas is to maintain the fluidization state of the oxygen carrier inside the fuel reactor 3, and the role of the jet gas is to create a local negative pressure in the first L-shaped jet chamber 3-6 and the second L-shaped jet chamber 3-15 to thereby entrain the organic pyrolysis gas of solid waste from the pyrolysis gasifier 4. Further, the pyrolysis gas is fully reacted with the fluidized oxidized oxygen carrier in the fuel reactor 3 to achieve combustion of the pyrolysis gas.

For the pyrolysis gasifier 4, the organic solid waste material is continuously fed into the storage bin 4-1 and transported by the spiral feeder 4-2 to the pyrolysis gasifier 4 (some baffles are provided along the flue descent in the pyrolysis gasifier to extend the residence time of the organic solid waste in the pyrolysis gasifier to thereby achieve sufficient pyrolysis gasification). The lower part of the pyrolysis gasifier is equipped with a first jet gas nozzle 4-3 and a second jet gas nozzle 4-8, and the gas speed is controlled by the first jet gas control valve 4-4 and the second jet gas control valve 4-7. The high-speed jet may generate a local negative pressure at the inlet of the first L-shaped jet chamber 3-6 and the second L-shaped jet chamber 3-15 to draw the pyrolysis gas of solid waste into the first L-shaped jet chamber 3-6 and the second L-shaped jet chamber 3-15; and the residual slag after reaction of the solid waste is discharged from a first spiral slag discharge device 4-5 and a second spiral slag discharge device 4-6.

### Embodiment 1

For the method for removing pollutants from organic solid waste by pyrolysis coupled with chemical looping combustion, it is implemented by the apparatus for removing pollutants from organic solid waste by pyrolysis coupled with chemical looping combustion, and comprises following steps of:

S1: placing an oxygen carrier of 5% Ca-loaded iron ore respectively in an air reactor 1, a U-type refeeder 2, an oxygen carrier refeeder 1-8, and a fuel reactor 3; starting an air booster fan 1-1 that provides air, and taking the air as fluidized gas; and turning on an air switching valve 5, and controlling a gas flow rate of the air reactor 1, fuel reactor 3, U-type refeeder 2 and oxygen carrier refeeder 1-8 by controlling an air control valve 1-2, a refeeder gas control valve 2-1, a first jet gas control valve 3-11, a fluidized gas control valve 3-8 and a second jet gas control valve 3-12 to realize cyclic fluidization of the oxygen carrier;

S2: turning on a second natural gas control valve 3-10 and a third natural gas control valve 3-13 to increase input of natural gas, igniting the natural gas by a first electric spark igniter 3-4 and a second electric spark igniter 3-16 in the fuel reactor, and transporting the flue gas and the reduced oxygen carrier to the air reactor 1 via the U-type refeeder 2; turning on the first natural gas control valve 1-5 to burn the natural gas in the air reactor 1, and sequentially turning off the first natural gas control valve 1-5, the second natural gas control valve 3-10, and the third natural gas control valve 3-13 after both the air reactor 1 and the fuel reactor 3 are raised to 800° C.-1000° C.; and meanwhile turning off the air switching valve 5, turning on a flue gas booster fan 3-2 on an outlet pipe of the second cyclone separator, and turning on a flue gas bypass control valve 3-1 on the outlet pipe of the second cyclone separator to switch the fluidized gas and jet gas of the fuel reactor 3 as recirculate flue gas in the outlet pipe of the second cyclone separator of the fuel reactor 3;

S3: continuously feeding sludge in the storage bin 4-1 into the pyrolysis gasifier 4 via a spiral feeder 4-2, and meanwhile turning on the first jet gas control valve 4-4 and the second jet gas control valve 4-7, such that pyrolysis gas in the pyrolysis gasifier 4 is sucked into the fuel reactor 3 by negative pressures generated in the first L-shaped jet chamber 3-6 and the second L-shaped jet chamber 3-15 and further undergoes chemical looping combustion under the action of oxygen carrier; then, acquiring the reduced oxygen carrier after reaction of the oxidized oxygen carrier, and discharging residual solids as remained after reaction of the organic solid waste from a lower part of the pyrolysis gasifier 4 via the first slag discharge device 4-5 and the second slag discharge device 4-6; and

S4: making the reduced oxygen carrier after reaction enter the U-type refeeder 2 and then enter the air reactor 1 under the refeeder gas; fully oxidizing the reduced oxygen carrier in an air atmosphere to acquire the oxidized oxygen carrier, and releasing heat which is absorbed by the oxidized oxygen carrier and oxygen-poor air after reaction; then, transporting the oxidized oxygen carrier and the oxygen-poor air to the first cyclone separator 1-7 via the top delivery pipe 1-6 after they enter a fast bed at an upper part of the air reactor 1, and separating the oxygen-poor air from the oxidized oxygen carrier, such that the oxidized oxygen carrier finally falls into the fuel reactor 3 via the oxygen carrier refeeder 1-8; and providing an oxygen source for combustion of the pyrolysis gas via the oxidized oxygen carrier, and providing heat to maintain reaction of the chemical looping combustion.

### Embodiment 2

The difference from Embodiment 1 is that the oxygen carrier becomes an oxygen carrier of 5% K-loaded iron ore.

### Embodiment 3

The difference from Embodiment 1 is that the oxygen carrier becomes an oxygen carrier of 5% Na-loaded iron ore.

### Embodiment 4

The difference from Embodiment 1 is that treatment of the solid waste is agricultural and forestry organic solids, and the oxygen carrier turns into a Fe-based oxygen carrier.

### Embodiment 5

The difference from Embodiment 1 is that the treatment of solid waste is agricultural and forestry organic solids, and the oxygen carrier turns into a Fe-based oxygen carrier and water vapor.

### Embodiment 6

The difference from Embodiment 1 is that the treatment of solid waste is agricultural and forestry organic solids, and the oxygen carrier turns into a NiFe₂O₄ oxygen carrier.

Control Group 1

The difference from Embodiment 1 is that the oxygen in air is directly used as the oxidant instead of the oxygen carrier to achieve the reaction in Embodiment 1.

Control Group 2

The difference from Embodiment 1 and Control Group 1 is that no oxidant (including air and oxygen carrier) is used, and the feedstock undergoes thermal decomposition only under the condition of high temperature and absence of oxygen.

The nitric oxides as acquired from Embodiment 1 and Control Group 1 are compared as shown in Table 1.

TABLE 1
Comparison in emission of NOₓ between the combustion modes

| | Total production | |
|---|---|---|
| Combustion modes | rate of NOₓ | Types of NOₓ |
| Air combustion | >1.76% | NO, NO₂, N₂O |
| Chemical looping | <0.78% | NO |
| combustion | | |

The reason why the emissions of NOₓ from chemical looping combustion are much less than those from air combustion is that the special conditions of the chemical looping process can inhibit or even completely block the formation of the three main NOₓ. Firstly, the low temperature of chemical looping combustion (<1000° C.) is much lower than that of air combustion, such that the generation of thermal NOₓ can be avoided completely. Secondly, the fuel is fully isolated from the nitrogen element in the air during the reaction, which fundamentally avoids the generation of fast NOₓ. Most critically, the fuel reaction does not involve gaseous molecular oxygen, the oxidation of the reaction atmosphere is significantly weakened, and the chance of generating the fuel-based NOₓ is significantly reduced. The pyrolysis of solid waste may produce NOₓ precursors mainly including HCN and NH₃, which can be directly oxidized to harmless N₂ by oxygen carriers. As shown in Table 1, the chemical looping combustion can significantly reduce the generation of NOₓ compared to the air combustion. As shown in FIG. 4, compared with the pyrolysis, the content of HCN and NH₃ can be effectively reduced in all the chemical looping combustion adopting different oxygen carriers. Thus, the pyrolysis coupled with chemical looping combustion has great advantages in the reduction of N-containing pollutants, which can reduce the investment in SNCR/SCR and other denitrification equipment, and thereby save the initial investment in denitrification and the operation-maintenance cost.

The desulfurization efficiencies as acquired from Embodiment 1 and Control Group 1 are compared as shown in Table 2.

TABLE 2
Desulfurization efficiencies of different oxygen carriers

| Combustion modes | Desulfurization efficiency |
|---|---|
| Air combustion | ~0%, requiring a relatively large |
| | desulfurization facility |
| Chemical looping combustion (oxygen | ~50%, requiring a small |
| carrier of Ca-loaded iron ore) | desulfurization facility |

The chemical looping combustion may capture and solidify the element S in the oxygen carrier, thereby achieving the removal of pollutant S. The sulfur release pattern of chemical looping combustion is similar to that of the air combustion, and the reduced pollutants S, such as H₂S and COS, as produced by pyrolysis of the solid waste are oxidized to SO₂ under the action of the oxygen carrier. The difference from air combustion is that the oxygen carrier can be modified to acquire the ability to absorb solidified SO₂, such as loading alkali (soil) metal components, to convert the gaseous SO₂ into stable sulfate solids, thereby achieving removal of the pollutant S. As shown in Table 2, the chemical looping combustion can achieve source desulfurization and reduce the corrosion of S-containing flue gas to the tail flue. The desulfurization efficiency in Example 1 is close to 50%, and can thereby be achieved by a small desulfurization facility, whereas the air combustion requires a large desulfurization facility, which adds costs to pollutant treatment in terms of the site and the operation-maintenance.

The dechlorination efficiencies as acquired from Embodiment 1, Embodiment 2, Embodiment 3 and Control Group 1 are compared as shown in Table 3.

TABLE 3
Dechlorination efficiencies of different oxygen carriers

| Combustion modes | Dechlorination efficiency |
|---|---|
| Air combustion | ~0%, requiring an additional |
| | dechlorination facility |
| Chemcal looping combustion (oxygen | ~38% |
| carrier of 5% Ca-loaded iron ore) | |
| Chemical looping combustion (oxygen | ~80% |
| carrier of 5% K-loaded iron ore) | |
| Chemical looping combustion (oxygen | ~85% |
| carrier of 5% Na-loaded iron ore) | |

The pollutant Cl as produced by pyrolysis of the solid waste is mainly HCl, and the principle for removing the pollutant Cl is similar to that of the pollutant S. The oxygen carrier is modified to acquire the ability of absorbing solidified Cl, so as to achieve the source removal of pollutant Cl and reduce the corrosion of the flue gas containing Cl to the gas flue. As shown in Table 3, the source dechlorination can be achieved by selecting a suitable oxygen carrier.

The tar contents in the flue gas as acquired from Embodiment 4, Embodiment 5, Embodiment 6 and Control Group 2 are compared as shown in Table 4.

TABLE 4
Comparison in tar contents

| | Tar content |
|---|---|
| | in flue gas |
| Conversion mode | (g/Nm³) |
| Pyrolysis | 36.23 |
| Chemical looping conversion (Fe-based oxygen carrier) | 10.25 |
| Chemical looping conversion (Fe-based oxygen carrier + | 5.68 |
| water vapor) | |
| Chemical looping conversion (NiFh₂O₄ oxygen carrier) | 373 |

Compared with the combustion, the pyrolysis of solid waste has a lower temperature and generates a large amount of tar. In addition, the tar has a rather stable structure, and requires a very high temperature for decomposition under anaerobic conditions. The oxygen carrier is generally a transition metal oxide, which has oxidation activity to remove part of the tar. Furthermore, some reduction products of the oxygen carrier are excellent tar cracking catalysts, such as metal Fe and its low-valent oxides, metal Ni, and the like. As shown in Table 4, compared with the pyrolysis, the tar content of the flue gas in the chemical looping conversion process is significantly lower. Since the reaction process is similar to the chemical looping combustion, it also has the effect of removing the N/S/Cl pollutants.

The process of pyrolysis coupled with chemical looping combustion has the advantages of both pyrolysis and combustion, and overcomes the disadvantages of each. Thus, the process has a rather high practical value and application potential.

Described above are only preferred embodiments of the present invention. It should be noted that the preferred embodiments should not be considered as a limitation to the present invention, and the protection scope of the present invention should be subject to the scope defined by the claims. Those skilled in the prior art may make several improvements and modifications without departing from the spirit and scope of the present invention, and these improvements and modifications shall be regarded as the protection scope of the present invention.

What is claimed is:

1. An apparatus for removing pollutants from an organic solid waste by a pyrolysis coupled with a chemical looping combustion, comprising: an air reactor, a fuel reactors and a pyrolysis gasifier, wherein the pyrolysis gasifier is sleeved at an outside the fuel reactor; the air reactor is connected with the fuel reactor by a U-type refeeder; a top end of the air reactor is connected with a first end of a top delivery pipe, a second end of the top delivery pipe is connected with a top end of a first cyclone separator, and a bottom end of the first cyclone separator is connected with an oxygen carrier refeeder provided at a top end of the fuel reactor; an air inlet is provided at a bottom of the air reactor, a fluidized gas nozzle and a plurality of jet devices are provided at a lower part of the fuel reactor, and a feeder is provided at one side of the pyrolysis gasifier.

2. The apparatus for removing the pollutants from the organic solid waste by the pyrolysis coupled with the chemical looping combustion of claim 1, wherein the lower part of the fuel reactor is equipped with the fluidized gas nozzle, and a first jet device and a second jet device of the plurality of jet devices are disposed on two sides of the fluidized gas nozzle; the first jet device consists of a first jet nozzle and a first L-shaped jet chamber, the second jet device consists of a second jet nozzle and a second L-shaped jet chamber; a first jet gas nozzle and a second jet gas nozzle are provided on both sides of a bottom part of the pyrolysis gasifier; a jet gas in a first jet gas pipeline is ejected by the first jet nozzle at an inlet of the first L-shaped jet chamber, such that a first high-speed jet gas generates a first local negative pressure and thereby draws a pyrolysis gas of the organic solid waste within the pyrolysis gasifier into the first L-shaped jet chamber; and the jet gas in a second jet gas pipeline is ejected by the second jet nozzle at an inlet of the second L-shaped jet chamber, such that a second high-speed jet gas generates a second local negative pressure and thereby draws the pyrolysis gas of the organic solid waste within the pyrolysis gasifier into the second L-shaped jet chamber.

3. The apparatus for removing the pollutants from the organic solid waste by the pyrolysis coupled with the chemical looping combustion of claim 2, wherein the top end of the fuel reactor is connected with a second cyclone separator, such that a flue gas in the fuel reactor is separated from solids by the second cyclone separator; the flue gas from a gas-solid separation passes through an outlet pipe of the second cyclone separator and serves as the jet gas in jet gas pipelines at a bottom part of the fuel reactor, a fluidized gas entering the fluidized gas nozzle via a fluidized gas pipeline, and a refeed gas in a refeed gas pipeline.

4. The apparatus for removing the pollutants from the organic solid waste by the pyrolysis coupled with the chemical looping combustion of claim 3, wherein L refeeder gas pipeline is provided at a bottom part of the U-type refeeder for circulating a refeeder gas.

5. The apparatus for removing the pollutants from the organic solid waste by the pyrolysis coupled with the chemical looping combustion of claim 3, wherein a first natural gas inlet is provided at the bottom of the air reactor, the jet gas pipelines comprises the first jet gas pipeline and the second jet gas pipeline; the first jet gas pipeline is provided with a second natural gas inlet, and the second jet gas pipeline is provided with a third natural gas inlet.

6. The apparatus for removing the pollutants from the organic solid waste by h pyrolysis coupled with the chemical looping combustion of claim 5, wherein the air inlet is provided with an air control valve; a refeeder gas pipeline is provided with a refeeder gas control valve; the first natural gas inlet is provided with a first natural gas control valve, the second natural gas inlet is provided with a second natural gas control valve, the third natural gas inlet is provided with a third natural gas control valve; the fluidized gas pipeline is provided with a fluidized gas control valve, the first jet gas pipeline is provided with a first jet gas control valve, and the second jet gas pipeline is provided with a second jet gas control valve.

7. The apparatus for removing the pollutants from the organic solid waste by the pyrolysis coupled with the chemical looping combustion of claim 3, wherein the second cyclone separator is provided with a carbon dioxide capturing device on an outlet tube.

8. The apparatus for removing the pollutants from the organic solid waste by the pyrolysis coupled with the chemical looping combustion of claim 1, wherein a slag discharge device is provided on a lower part of the pyrolysis gasifier.

9. A method for removing pollutants from an organic solid waste by a pyrolysis coupled with a chemical looping combustion, implemented by the apparatus of claim 6, comprising steps of:
S1: placing an oxygen carrier respectively in the air reactor, the U-type refeeder, the oxygen carrier refeeder, and the fuel reactor; starting an air booster fan providing an air, taking the air as the fluidized gas; turning on an air switching valve, and controlling a gas flow rate of the air reactor, the fuel reactor, the U-type refeeder, and the oxygen carrier refeeder by controlling the air control valve, the refeeder gas control valve, the first jet gas control valve, the fluidized gas control valve, and the second jet gas control valve to realize a cyclic fluidization of the oxygen carrier;
S2: turning on the second natural gas control valve and the third natural gas control valve to increase an input of a natural gas, igniting the natural gas by an electric spark igniter in the fuel reactor, and transporting the flue gas and the oxygen carrier to the air reactor via the U-type refeeder; turning on the first natural gas control valve to burn the natural gas in the air reactor, and sequentially turning off the first natural gas control valve, the second natural gas control valve, and the third natural gas control valve after both the air reactor and the fuel reactor are raised to 800° C.-1000° C.; and meanwhile turning off the air switching valve, turning on a flue gas booster fan on the outlet pipe of the second cyclone separator, and turning on a flue gas bypass control valve on the outlet pipe of the second cyclone separator to switch the fluidized gas and the jet gas of the fuel reactor as recirculate the flue gas in the outlet pipe of the second cyclone separator of the fuel reactor;
S3: continuously feeding the organic solid waste of a storage bin into the pyrolysis gasifier via the feeder, and meanwhile turning on the first jet gas control valve and the second jet gas control valve, such that the pyrolysis gas in the pyrolysis gasifier is sucked into the fuel reactor by the first local negative pressure generated in the first L-shaped jet chamber and the second local negative pressure generated in the second L-shaped jet chamber and further undergoes the chemical looping combustion under an action of the oxygen carrier; acquiring a reduced oxygen carrier after a first reaction of an oxidized oxygen carrier, and discharging residual solids as remained after a second reaction of the organic solid waste from a lower part of the pyrolysis gasifier via a slag discharge device; and
S4: making the reduced oxygen carrier after the first reaction enter the U-type refeeder and then enter the air reactor under a refeeder gas; fully oxidizing the reduced oxygen carrier in an air atmosphere to acquire the oxidized oxygen carrier, and releasing a first heat absorbed by the oxidized oxygen carrier and an oxygen-poor air after a reaction;
transporting the oxidized oxygen carrier and the oxygen-poor air to the first cyclone separator via the top delivery pipe after the oxidized oxygen carrier and the oxygen-poor air enter a fast bed in an upper part of the air reactor, and separating the oxygen-poor air from the oxidized oxygen carrier, such that the oxidized oxygen carrier falls into the fuel reactor via the oxygen carrier refeeder; and providing an oxygen source for a combustion of the pyrolysis gas via the oxidized oxygen carrier, and providing a second heat to maintain a third reaction of the chemical looping combustion.

10. The method for removing the pollutants from the organic solid waste by the pyrolysis coupled with the chemical looping combustion of claim 9, wherein the oxygen carrier is a natural metallic ore selected from at least one of an iron ore, a copper ore, a manganese ore, and a nickel ore.
